(19) United States
(12) Patent Application Publication
(10) Pub. No.: US 2018/0297095 A1
(43) Pub. Date: Oct. 18, 2018

(54) Methods For Connecting Floor Slats To Drive Shoes

(71) Applicant: Keith Manufacturing Co., Madras, OR (US)

(72) Inventors: Daniel Jackson, Madras, OR (US); Nathan Keeley, Madras, OR (US)

(73) Assignee: Keith Manufacturing Co., Madras, OR (US)

(21) Appl. No.: 15/951,975

(22) Filed: Apr. 12, 2018

Related U.S. Application Data
(60) Provisional application No. 62/485,329, filed on Apr. 13, 2017.

(51) Int. Cl. B21C 23/14; B21D 28/26; B65G 17/06

(52) U.S. Cl. CPC B21C 23/14; B65G 17/063; B21D 28/26

(57) ABSTRACT

An all-steel floor slat for a reciprocating conveyor system includes a plurality of fastener openings through the top surface of the slat for connecting the slat to an underlying drive mechanism. The fastener openings are formed with counter-sinks for receiving fastener heads.

### TECHNICAL FIELD

The present disclosure relates to reciprocating floor slat conveyors and, more specifically, to methods for connecting all-steel floor slats to an underlying drive shoe.

### BACKGROUND

Reciprocating floor slat conveyors are well-known in the art. These systems generally involve an array of aluminum floor slats that are assembled as a trailer floor. The slats are hydraulically driven, back-and-forth, in a planned sequence that inches the load off the back-end of the trailer. Usually, all of the floor slats are moved in the same direction at the same time (toward the trailer's end). This movement translates the load an incremental distance outward. Then, the slats are returned, in the other direction, in a three-part sequence that involves moving (or reciprocating) one-third of the slats at a time. The lesser number of slats involved in the return allows frictional forces to hold the load's position and not shift the load back with the returning slats.

The above system has been used in the trucking industry to haul a variety of different kinds of materials, although it is well suited to materials hauled in bulk, like silage, sawdust, rock, or asphalt.

Because of weight and other considerations, the floor slats in the above system are traditionally extruded from aluminum. The slats are connected to transverse drive members that have drive shoes that are connected to the underside of the floor slat. Fasteners are used to physically make the slat-to-drive shoe connection. This general mode of construction is known in the art.

It is believed that reciprocating conveyor systems of the above kind can be improved for some hauling applications, if steel is swapped for the aluminum material that is currently used to make the floor slats. However, because of the different material characteristics of steel compared to aluminum, solving the various problems attributable to making functional steel slats is not obvious.

One problem that arises with steel slats is that the steel slat is necessarily thinner than conventional aluminum slats. This creates problems in the region of the steel slat where it is connected to the drive shoe, if the steel slat is connected according to conventional fastener methods.

The foregoing and other features will be better understood upon review of the drawings and description that follows.

### SUMMARY

One of the methods disclosed here involves putting a fastener counter-sink in an all-steel floor slat. In this case, the slat is made from a single strip of thin-walled steel that is formed into a desired cross-section. In accordance with the method disclosed here, the all-steel floor slat includes at least one fastener opening formed in a top surface portion of the slat. The fastener opening extends through the thickness of the slat so that the fastener may connect the slat to underlying drive structures. In this instance, the fastener opening is created by also forming the steel material around the opening, in a manner so as to create a downward counter-sink. The counter-sink is adapted to receive the head portion of the fastener. In practice, it is likely that a plurality of fastener openings would be made, in this manner, through the top surface of a single slat.

The above summary is not intended to limit the claiming of different embodiments described herein.

### BRIEF DESCRIPTION OF THE DRAWINGS

In the drawings, like reference numerals and letters refer to like parts throughout the various views, and wherein:

FIG. 1 is a pictorial representation of a section of an all-steel floor slat exploded from the top of a drive shoe that would be typically connected to conventional drive units for reciprocating floor slat systems;

FIG. 2 is a cross-section through FIG. 1;

FIG. 3 is a pictorial view of a different method for connecting the all-steel floor slat to the drive shoe;

FIG. 4 is a cross-section of FIG. 3;

FIG. 5 illustrates a third method for connecting an all-steel floor slat to the drive shoe;

FIG. 6 is a cross-section through FIG. 5;

FIG. 7 illustrates a fourth method for connecting an all-steel floor slat to the drive shoe;

FIG. 8 is a cross-section of FIG. 7;

FIG. 9 is a two-part view including, on the left-hand side (FIG. 9A), a side view of a cross-drive, and a sectional view (FIG. 10A) through the cross-drive on the right-hand side;

FIG. 10 is a three-part view showing a top plan view of a floor slat (FIG. 10A), an end view of the slat (FIG. 10B), and a side view of the slat (FIG. 10C); and

FIG. 11 is a series of two views (FIGS. 11A and 11B) showing floor slat connections to a drive shoe.

### DETAILED DESCRIPTION

Referring now to the drawings, the above methods will now be described.

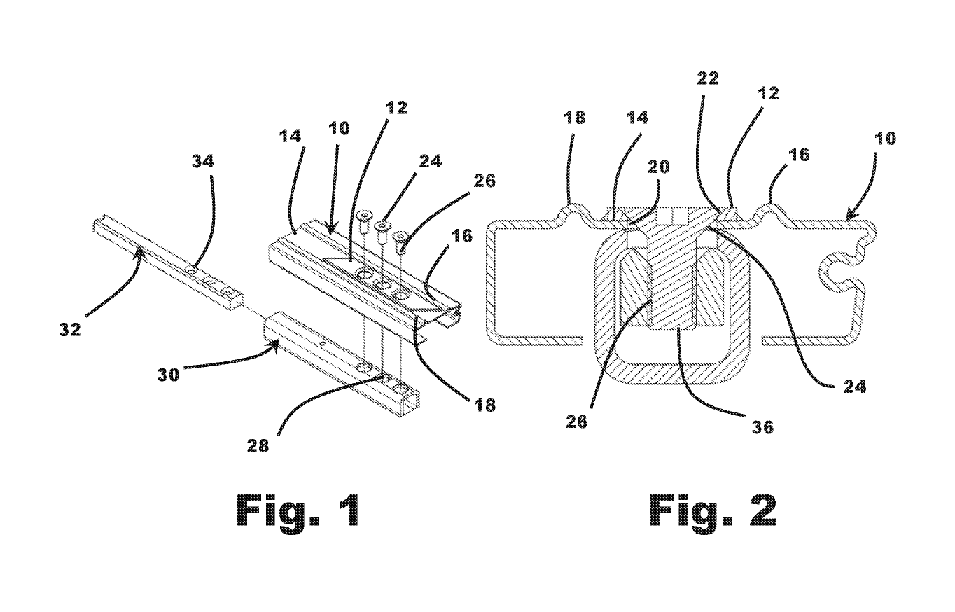

In the first method (FIGS. 1-2), the all-steel slat (indicated generally at 10) has a bolt bar 12 that is welded to the top surface 14 of the slat, between two slat ridges 16, 18. The top surface of the bolt bar 12 does not exceed the vertical height of the slat ridges 16, 18 (see FIG. 2).

As seen in FIG. 2, the bolt bar 12 is welded to the top surface 14 of the slat 10 over fastener holes 20 that are pre-drilled or possibly punched in the slat 10. The bolt bar has countersinks (indicated at 22 in FIG. 2) for matching the tapered head 24 of each fastener 26 (all of the fasteners are indicated by reference numeral 26). The fasteners extend down through holes or openings 28 in the drive shoe (indicated generally by 30).

The drive shoe 30 is hollow and receives a nut bar, indicated generally at 32. The nut bar has threaded openings 34 for receiving the threaded end 36 (see FIG. 2) of the fastener 26, for screwing down the floor slat 10 to the drive shoe 30, with the bolt bar 12 creating reinforcing structure at the high stress areas created by the drive shoe forces that are translated to the slat 10.

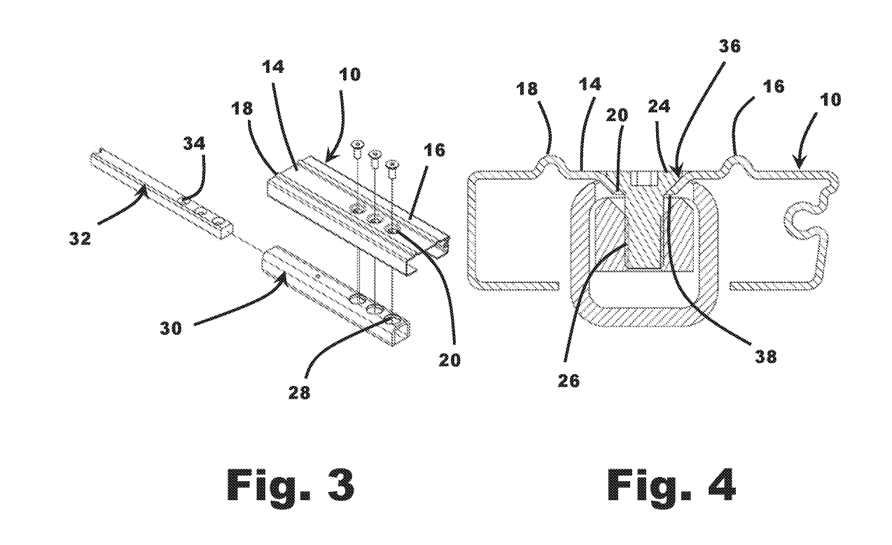

Referring now to FIGS. 3-4, a second method for attaching the steel slat 10 will now be described. In this method, the slat 10 itself is countersink punched, as indicated by reference numeral 36 in FIG. 4. This can be accomplished in one step by punching the fastener center hole and drawing the slat material downward to form the countersink simultaneously. Alternatively, the fastener opening in the slat (indicated at 38) can be pre-drilled or punched, with the countersink formed as a second step or secondary operation. The nut bar connection is essentially the same as the method illustrated in FIGS. 1-2.

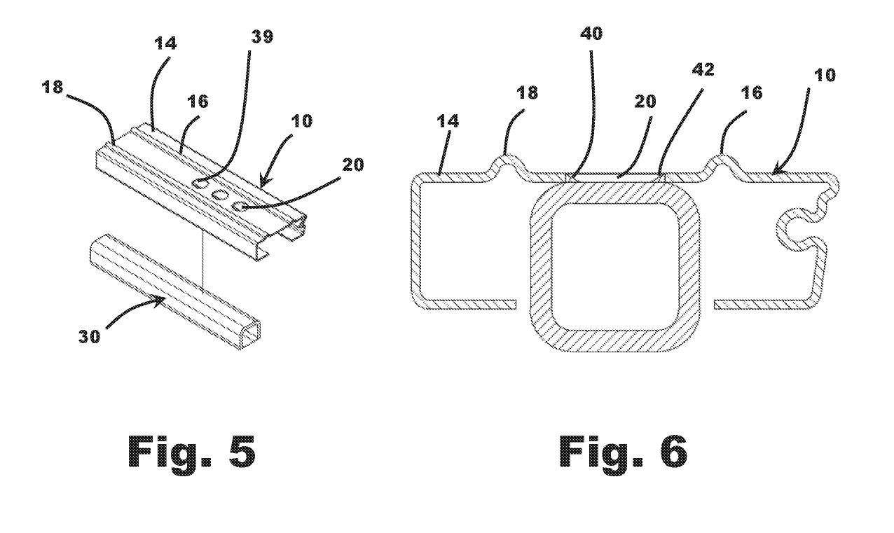

A third method is illustrated in FIGS. 5-6. In this method, the slat 10 has fastener openings 39 (see FIG. 5) that are either punched or pre-drilled through the thickness of the slat. The slat is then welded to the drive shoe 30 (the welds are shown at 40, 42 in FIG. 6). This method eliminates the nut bar 32 that was illustrated in the previous two methods described.

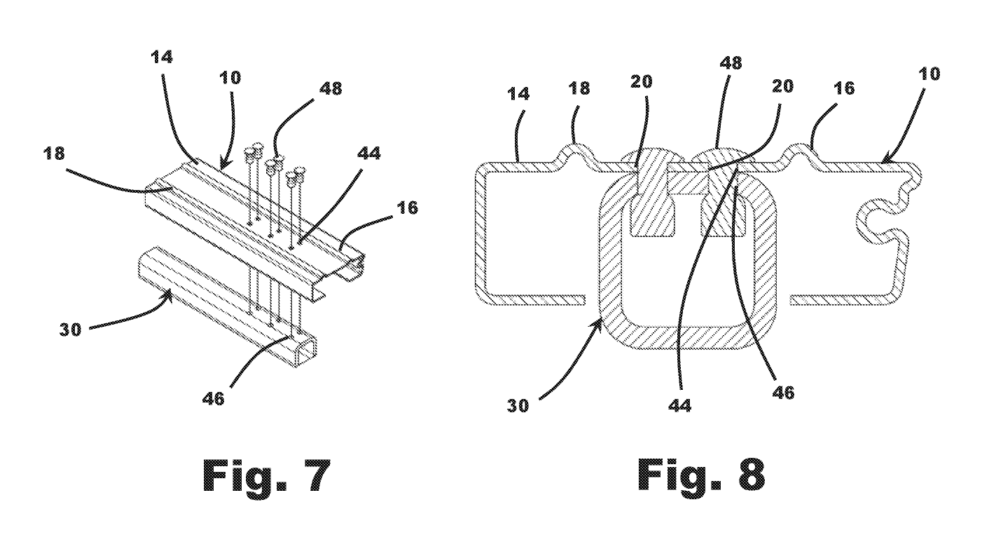

The fourth method is illustrated in FIGS. 7-8. In this method, the slat 10 and drive shoe 30 are pre-drilled with matching holes. The holes in the slat (six of them) are indicated by reference numeral 44 in FIG. 7. The holes in the drive shoe 30 are indicated by reference numeral 46. These various holes 44, 46 are matched during installation and fastened together by blind rivets 48 (see FIG. 8). This last method also eliminates the nut bar 32.

FIGS. 9-11 show yet another method for attaching a steel slat 10 to a cross-drive member that is part of a drive system for a reciprocating floor slat conveyor. Referring first to FIG. 9, reference numeral 50 points to a typical cross-drive shown in cross-section for a conveyor drive system. As is known, a typical conveyor drive system has three cross-drives, corresponding to one-third of the floor slats. A cross-drive, typically carries a plurality of drive shoes.

Reference numeral 52 indicates a side-view of a different type of attachment point for a drive shoe, described below. The left-hand side of FIG. 9 shows the attachment point 52 looking at the end (side view of cross-drive). Referring to the right-hand side of FIG. 9, each attachment point has a series of fastener openings 54.

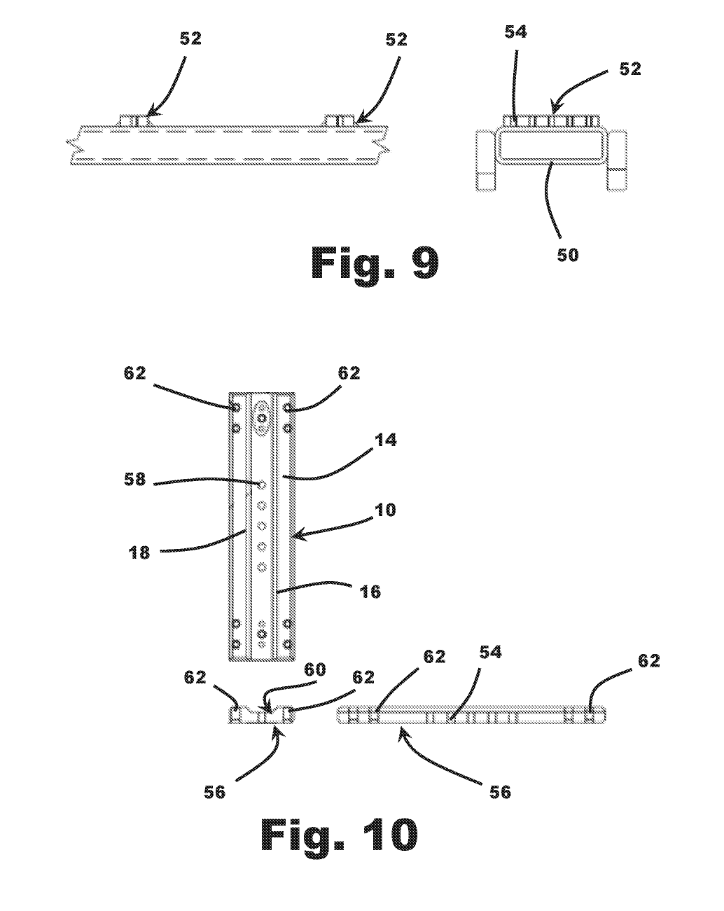

Referring now to FIG. 10, reference numeral 56 generally indicates the drive shoe, which is a separate member connected to the attachment point 52 described above. The first or topmost view of FIG. 10 illustrates a series of through holes 58 that are used to fasten the drive shoe 56 to the attachment point 52 below (with through holes 58 matching to fastener openings 54). The drive shoe 56 is recessed in the center, as shown at 60 in the lower part of figure of 10. Each drive shoe 56 has a plurality of lateral fastener openings 62 running along the outer edges of the drive shoe. In the example illustrated in FIG. 10, the drive shoe 56 has four lateral fastener openings 62 on each side.

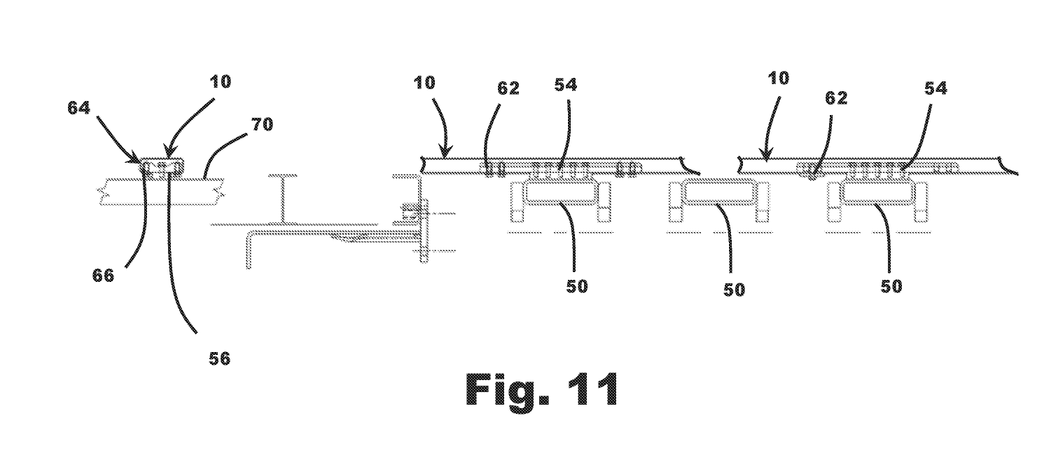

Referring now to FIG. 11, the floor slat is schematically indicated at 10. Referring to the left-hand side of FIG. 11, which shows a cross-sectional view of the floor slat 10 mounted to the drive shoe 56, it can be seen that the lower lateral edges of the floor slat are bent underneath the drive shoe 56, as generally indicated at 64. According to other provisional filings, these lateral edges would be roll formed when the slat 10 is made. Fasteners 66 then connect the floor slat 10 to the drive shoe 56 from underneath.

Referring again to FIG. 9, the vertical height of the attachment point 52 (height is generally indicated by arrow 68) is sufficient to create a gap above the upper surface 70 of the cross-drive 50. This allows space for connecting the floor slat 10 to the drive shoe 56 in the manner shown on the left-hand side of FIG. 11. The vertical height is also shown at 68 on the right-hand side of FIG. 11.

An important feature to the methods described above is that there are no fastener heads protruding vertically on the upper surface of the all steel slat 10. The lack of vertical fastener head protrusions means that there are no catch points for sliding palleted loads, or the like, across an all-steel floor that consists of reciprocating floor slats. The slat to drive shoe connection method illustrated in FIGS. 9-11 also serves as a means of reducing localized stresses at the points where fasteners are used to connect a slat to a drive shoe.

The foregoing description is not intended to limit the scope of patent coverage. The scope of patent coverage is to be limited only by the patent claims allowed by the customs of local law, the interpretation of which is to be made in accordance with the doctrines of patent claim interpretation for the applicable jurisdiction.

What is claimed is:

1. A method of forming an all-steel floor slat for use in a reciprocating floor slat conveyor system, the method comprising:
forming a conveyor slat from an all-steel material, with the slat having a top surface portion;
creating at least one fastener opening through said top surface portion; and
forming said steel material surrounding said fastener opening in a manner so as to create a downward counter-sink comprising said material that surrounds said fastener opening, for receiving a fastener head.
